(19) United States
(12) Patent Application Publication
(10) Pub. No.: US 2020/0312499 A1
(43) Pub. Date: Oct. 1, 2020

(54) SOFT MAGNETIC ALLOY AND MAGNETIC PART

(71) Applicant: TDK CORPORATION, Tokyo (JP)

(72) Inventors: Hironobu KUMAOKA, Tokyo (JP); Akito HASEGAWA, Tokyo (JP); Hiroyuki MATSUMOTO, Tokyo (JP); Kazuhiro YOSHIDOME, Tokyo (JP)

(73) Assignee: TDK CORPORATION, Tokyo (JP)

(21) Appl. No.: 16/829,735

(22) Filed: Mar. 25, 2020

(30) Foreign Application Priority Data
Mar. 26, 2019 (JP) 2019-059144

(51) Int. Cl. H01F 1/153; C22C 45/02

(52) U.S. Cl. CPC H01F 1/153; C22C 2202/02; C22C 45/02

(57) ABSTRACT

A soft magnetic alloy contains Fe as a main element and has an amorphous phase. On a differential scanning calorimetry curve of the soft magnetic alloy, a glass transition temperature Tg is found in a range from 350° C. to 600° C. and three or more exothermic peaks are found in a range from 350° C. to 850° C.

### BACKGROUND OF THE INVENTION

The present invention relates to a soft magnetic alloy and a magnetic part.

In recent years, there is a demand for higher efficiency and lower power consumption in electronic, information, and communication equipment or the like. Furthermore, the above demand is further strengthened for the realization of a low-carbon society. Therefore, there is also a demand for improvement of power supply efficiency and reduction of energy loss in a power supply circuit for the electronic, information, and communication equipment or the like. As a result, there is a demand for improvement of saturation magnetic flux density and reduction of core loss (magnetic core loss) in a magnetic core included in a magnetic part used in the power supply circuit. If the core loss is reduced, the energy loss of the power supply circuit decreases, and high efficiency and energy saving of the electronic, information, and communication equipment or the like can be achieved.

As one of methods for decreasing the core loss, it is effective to configure a magnetic core of a magnetic material having high soft magnetic properties. For example, Patent Document 1 discloses a soft magnetic alloy which has an Fe-A-B—X-based composition and primary ultrafine-crystals dispersed in the amorphous. Incidentally, A is Cu and/or Au, and X is at least one selected from Si, S, C, P, Al, Ge, Ga, and Be.

Patent Document 1: PCT International Publication No. 2011/122589

The soft magnetic alloy disclosed in Patent Document 1 which has the primary ultrafine-crystals dispersed in the amorphous becomes a nanocrystalline alloy having fine crystals (nanocrystals) dispersed in the amorphous through a heat treatment.

However, a problem arises in that the soft magnetic alloy having the primary ultrafine-crystals will have low amorphous-forming ability. Therefore, when the soft magnetic alloy having the primary ultrafine-crystals is subjected to the heat treatment, the amorphous is likely to be crystallized, and grain growth of the nanocrystals are likely to occur. As a result, the soft magnetic properties are caused to deteriorate. In this respect, in order to suppress the grain growth of the nanocrystals, a temperature rising rate during the heat treatment increases.

When the temperature rising rate during the heat treatment increases, a load to a heat treatment furnace increases, and thus a problem arises in that the furnace will be damaged. When an amount of powder increases in the furnace, a problem arises in that heat transfer to the powder will be delayed and thus a desired temperature rising rate is not uniformly achieved.

### SUMMARY OF THE INVENTION

The invention is made with consideration for such circumstances, and an object thereof is to provide a soft magnetic alloy having high amorphous-forming ability.

According to an aspect of the invention, [1] a soft magnetic alloy contains Fe as a main component and has an amorphous phase. On a differential scanning calorimetry curve of the soft magnetic alloy, a glass transition temperature Tg is found in a range from 350° C. to 600° C. and three or more exothermic peaks are found in a range from 350° C. to 850° C.

[2] In the soft magnetic alloy according to [1], a composition of the soft magnetic alloy is represented by a composition formula of (Fe_{(1-(α+β))}X1_{α}X2_{β})_{(1-(a+b+c+d+e+f))}MₐB_{b}P_{c}Si_{d}CₑS_{f}, X1 is at least one selected from the group consisting of Co and Ni, X2 is at least one selected from the group consisting of Al, Mn, Ag, Zn, Sn, As, Sb, Cu, Cr, Bi, N, O, and rare earth elements, M is at least one selected from the group consisting of Nb, Hf, Zr, Ta, Mo, W, Ti, and V, a, b, c, d, e, f, α, and β satisfy relationships of 0≤a≤0.140, 0.020<b≤0.200, 0≤c≤0.150, 0≤d≤0.175, 0≤e≤0.030, 0≤f≤0.010, α≥0, β≥0, and 0≤α+β≤0.50, and at least one of c and d is larger than 0.

[3] In the soft magnetic alloy according to [1] or [2], a, b, c, d, e, and f satisfy a relationship of 0.73≤(1−(a+b+c+d+e+f))≤0.91.

[4] In the soft magnetic alloy according to any one of [1] to [3], the soft magnetic alloy consists of amorphous.

[5] In the soft magnetic alloy according to any one of [1] to [3], the soft magnetic alloy has a nanoheterostructure in which initial fine crystals are present in the amorphous phase.

[6] In the soft magnetic alloy according to any one of [1] to [5], the soft magnetic alloy has a ribbon shape.

[7] In the soft magnetic alloy according to any one of [1] to [5], the soft magnetic alloy has a powder shape.

[8] A magnetic part includes the soft magnetic alloy according to any one of [1] to [7].

[9] A magnetic part includes a soft magnetic alloy obtained by performing a heat treatment on the soft magnetic alloy according to any one of [1] to [7] and having Fe-based nanocrystals.

According to the invention, it is possible to provide the soft magnetic alloy having high amorphous-forming ability.

### BRIEF DESCRIPTION OF THE DRAWINGS

FIG. 1 is an example of an X-ray diffraction chart which is obtained through X-ray crystal structure analysis.

FIG. 2 is an example of a pattern which is obtained by performing profile fitting on the X-ray diffraction chart illustrated in FIG. 1.

FIG. 3 is a graph illustrating an example of a differential scanning calorimetry curve of a soft magnetic alloy according to an embodiment.

FIG. 4A is a schematic cross-sectional view of an example of an atomization apparatus for manufacturing the soft magnetic alloy according to the embodiment.

FIG. 4B is an enlarged sectional view illustrating main parts of the atomization apparatus illustrated in FIG. 4A.

FIG. 5 is a graph illustrating differential scanning calorimetry curves of samples according to an example and a comparative example of the invention.

### DETAILED DESCRIPTION OF THE PREFERRED EMBODIMENTS

Hereinafter, the invention will be described in detail in the following order, based on a specific embodiment illustrated in the drawings.

1. Soft Magnetic Alloy

2. Method for Manufacturing Soft Magnetic Alloy

3. Magnetic Part

1. Soft Magnetic Alloy

A soft magnetic alloy according to the embodiment is an amorphous alloy which is obtained by rapidly cooling melted metal containing raw materials of a soft magnetic alloy. Here, it is preferable that the soft magnetic alloy do not contain a crystalline phase having a crystal grain size of larger than 30 nm.

In the embodiment, after a heat treatment of the soft magnetic alloy, Fe-based nanocrystals are likely to be obtained, and good soft magnetic properties is likely to be obtained. In this respect, it is preferable that the soft magnetic alloy be configured only of amorphous, or it is preferable that the soft magnetic alloy have a nanoheterostructure in which initial fine crystals are dispersed in an amorphous phase. An average crystal grain size of the initial fine crystals is preferably 0.3 nm or larger and 10 nm or smaller.

In the embodiment, whether the soft magnetic alloy has a structure having the amorphous phase or a structure configured of a crystalline phase is determined using the following amorphous phase ratio. In the embodiment, when the amorphous phase ratio X obtained by Expression (1) is 85% or higher, the soft magnetic alloy has the structure having the amorphous phase, and when the amorphous phase ratio X is lower than 85%, the soft magnetic alloy has the structure configured of the crystalline phase.

X=100−(Ic/(Ic+Ia)×100) Expression (1)

Ic: Scattering Integral Intensity originated from crystal
Ia: Scattering Integral Intensity originated from amorphous

X-ray crystal structure analysis of the soft magnetic alloy is performed by XRD, phase identification is performed, peaks (Ic: scattering integral intensity originated from crystal and Ia: scattering integral intensity originated from amorphous) of crystallized Fe or compound are read, a crystallization rate is determined from peak intensity of the peaks, and the amorphous phase ratio X is calculated by Expression (1). Hereinafter, a calculation method is more specifically described.

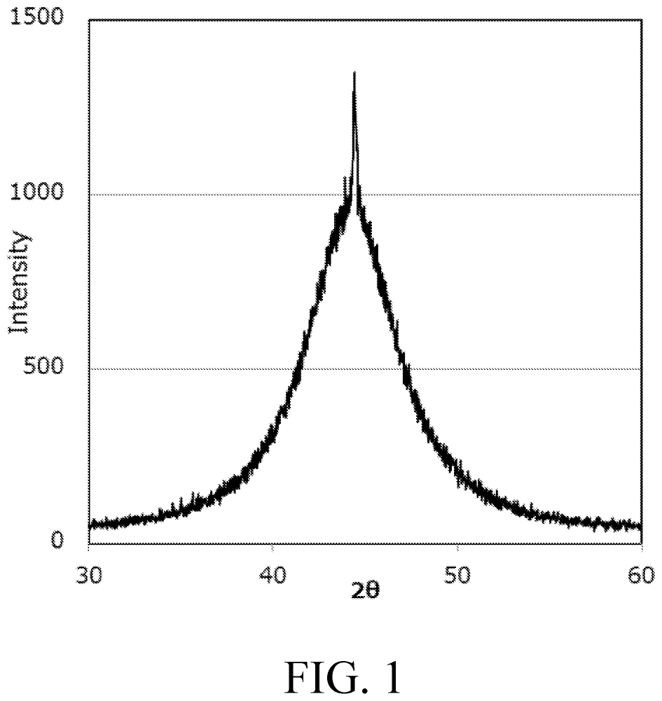

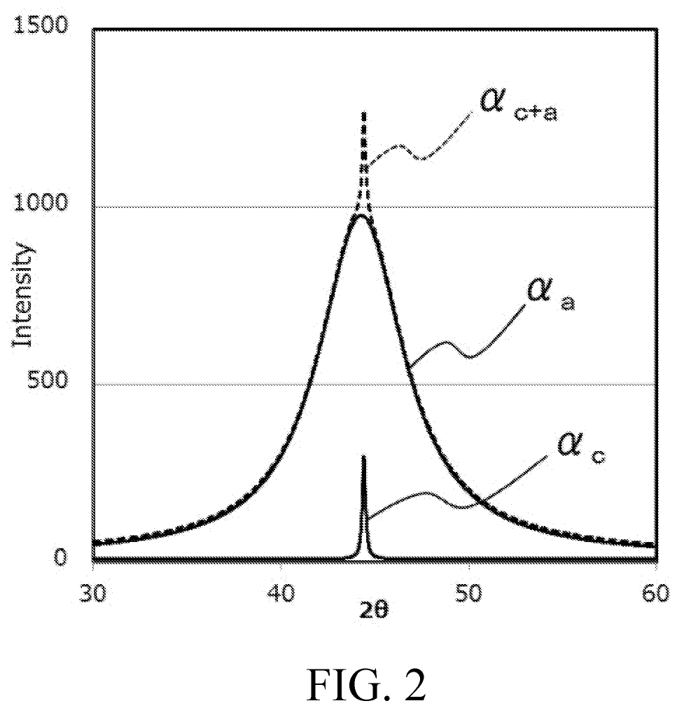

The X-ray crystal structure analysis is performed on the soft magnetic alloy according to the embodiment by the XRD, and a chart as illustrated in FIG. 1 is obtained. The chart is subjected to profile fitting by using a Lorentz function of Expression (2), and a crystalline component pattern α_{c} representing the scattering integral intensity originated from crystal, an amorphous component pattern αₐ representing the scattering integral intensity originated from amorphous, and a pattern α_{c+a} obtained by combining both the crystalline component pattern and amorphous component pattern, as illustrated in FIG. 2. The amorphous phase ratio X is obtained by Expression (1), from the scattering integral intensity originated from crystal and the scattering integral intensity originated from amorphous of the obtained patterns. Incidentally, a measurement range is a range of a diffraction angle 2θ which is 30° to 60° in which a halo derived from an amorphous can be identified. In this range, the amorphous phase ratio is calculated so as to maintain an error of 1% or lower between an integral intensity actually measured by the XRD and an integral intensity calculated using the Lorentz function.

$$f ( x ) = \frac{h}{1 + \frac{{( x - u )}^{2}}{{w}^{2}}} + b \qquad Expression ( 2 )$$

### h: Peak Height

### u: Peak Position

### w: Half-value Width

### b: Background Height

The soft magnetic alloy according to the embodiment has a glass transition temperature (Tg) in a range from 350° C. to 600° C. In other words, the soft magnetic alloy according to the embodiment has a supercooled liquid region. Hence, the soft magnetic alloy according to the embodiment has higher amorphous-forming ability and a more stable amorphous phase than a soft magnetic alloy which does not have the glass transition temperature has. That is, crystallization of the amorphous phase is unlikely to occur, and thus the grain growth of the initial fine crystals and/or deposition and growth of the Fe-based nanocrystal is suppressed, even when the heat treatment is performed on the soft magnetic alloy according to the embodiment. Further, self-heating is suppressed by dispersing exothermic peaks. As a result, even when a temperature rising rate during the heat treatment decreases, fine Fe-based nanocrystals are obtained. In other words, since the heat treatment can be stably performed, formation of the Fe-based nanocrystals can be controlled.

In addition, the soft magnetic alloy according to the embodiment has three or more exothermic peaks in a range from 350° C. to 850° C. on a differential scanning calorimetry (DSC) curve of the soft magnetic alloy. In the embodiment, the number of exothermic peaks is preferably four or more. In addition, the upper limit of the number of the exothermic peaks is not limited; however, the upper limit is six, for example.

The exothermic peaks are peaks derived from crystallization of the amorphous phase. In the embodiment, the exothermic peaks include at least a peak derived from the formation of the Fe-based nanocrystal having a body-centered cubic lattice (bcc) structure. When a peak at the lowest temperature side of the exothermic peaks is set as a first exothermic peak, a temperature at the first exothermic peak is present on a temperature side higher than the glass transition temperature.

Incidentally, the exothermic peaks of a soft magnetic alloy having a composition to be described below include a peak derived from the formation of the Fe-based nanocrystal and a peak derived from the formation of an iron compound of Fe—B or the like, and a peak derived from the formation of the Fe-based nanocrystal becomes the first exothermic peak. In addition, an exothermic peak at a temperature approximate to 700° C. to 850° C. is derived from the formation of Fe—B, and thus an exothermic peak at a temperature higher than that tends to degrade soft magnetic properties of a material.

In addition, the peaks derived from the formation of the Fe-based nanocrystal preferably include a peak, in addition to the first exothermic peak, and the number of peaks derived from the Fe-based nanocrystal is preferably three or more. The number of peaks is three or more, and thereby exothermic heat due to the formation of the Fe-based nanocrystal is dispersed. Thus, a heat treatment for obtaining the fine Fe-based nanocrystals can be stably performed.

In the embodiment, whether or not an exothermic peak is found on the differential scanning calorimetry curve can be determined from a differential curve of the differential scanning calorimetry curve of the soft magnetic alloy according to the embodiment. In addition, whether or not the glass transition temperature is found on the differential scanning calorimetry curve can be also determined from the differential curve of the differential scanning calorimetry curve of the soft magnetic alloy according to the embodiment.

First, baseline correction is performed on the differential scanning calorimetry curve which is obtained by performing measurement at a predetermined temperature rising rate (40 K/min or higher). In the embodiment, in regard to the differential values at each temperature changing by 0.1° C. on a corrected differential scanning calorimetry curve, a differential curve (DDSC) is calculated by performing plotting of average values of differential values at ten points above and below each temperature, and a maximum turning point on the differential curve is set as a point indicating the exothermic peak. Besides, the number of exothermic peaks is calculated in the range from 350° C. to 850° C.

In addition, in regard to the differential values on the differential scanning calorimetry curve at a temperature side lower than the first exothermic peak, a differential curve (DDSC) is calculated by performing plotting of average values of differential values at ten points above and below each temperature. Besides, when a temperature at which the average value is 0 is present, and an average value of DDSC is a negative value over temperatures higher than the temperature by 10° C. or more, a temperature at a point at which the average value of DDSC is 0 is set as the glass transition temperature (Tg).

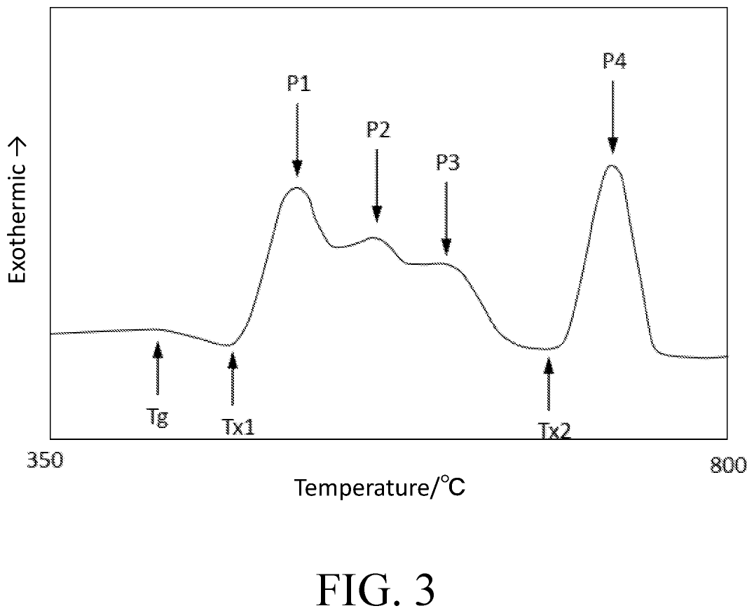

FIG. 3 illustrates a typical example of the differential scanning calorimetry curve of the soft magnetic alloy which has the glass transition temperature and three or more exothermic peaks. In FIG. 3, the differential scanning calorimetry curve falls to the right at a temperature side higher than Tg, that is, the average value of the DDSC is the negative value. Hence, the Tg is determined as the glass transition temperature.

In addition, in FIG. 3, four exothermic peaks (P1 to P4) are present at the temperature side higher than Tg. Incidentally, when a maximum turning point is present on the DDSC, a shoulder-shaped curve as represented by P3 is also determined as the exothermic peak.

In addition, in FIG. 3, for example, in a case where P1 to P3 are peaks derived from the formation of the Fe-based nanocrystals, and P4 is a peak derived from the formation of the iron compound, and when the average value of the DDSC becomes a positive value from the negative value at the temperature side higher than Tg, a temperature at which the average value of the DDSC is 0 is set as a first crystallization temperature (Tx1). In addition, when the average value of the DDSC becomes a positive value from the negative value at a temperature side higher than P3, a temperature at which the average value of the DDSC is 0 is set as a second crystallization temperature (Tx2). In other words, a temperature at which a peak derived from the formation of the iron compound at a high temperature side around 700° C. to 850° C. starts to rise is set as Tx2.

Incidentally, which crystalline formation causes the exothermic peak can be determined by performing the heat treatment on the soft magnetic alloy according to the embodiment while a heat-treatment temperature changes and identifying a configuration phase of a thermally treated alloy by using X-ray diffraction measurement, for example.

The soft magnetic alloy according to the embodiment is not particularly limited, as long as the soft magnetic alloy according to the embodiment has the glass transition temperature and three or more exothermic peaks in a predetermined temperature range. In the embodiment, it is preferable that the soft magnetic alloy have the following composition. The composition causes to easily obtain good amorphous-forming ability and good magnetic properties.

The composition of the soft magnetic alloy is represented by a composition formula of (Fe_{(1-(α+β))}X1_{α}X2_{β})_{(1-(a+b+c+d+e+f))}MₐB_{b}P_{c}Si_{d}CₑS_{f}.

In the above-described composition formula, M is at least one element selected from the group consisting of Nb, Hf, Zr, Ta, Mo, W, Ti, and V.

In addition, “a” represents an M content, and “a” satisfies 0≤a≤0.14. That is, M is an optional element. The M content (a) is, preferably, 0.040 or larger and, more preferably, 0.050 or larger. The M content (a) is, preferably, 0.100 or smaller and, more preferably, 0.080 or smaller.

When “a” is too small, a crystalline phase which is configured of crystals having a grain size of larger than 30 nm is likely to be formed in the soft magnetic alloy. When the crystalline phase is formed, it is not possible to deposit the Fe-based nanocrystals through the heat treatment. As a result, specific resistance of the thermally treated soft magnetic alloy tends to easily decrease. Further, coercivity thereof tends to easily increase. On the other hand, when “a” is too large, the saturation magnetization or the saturation magnetic flux density of the thermally treated soft magnetic alloy tends to easily decrease.

In the above-described composition formula, “b” represents a boron (B) content, and “b” satisfies 0.020<b≤0.200. The B content (b) is preferably 0.025 or larger, more preferably 0.060 or larger, and still more preferably 0.080 or larger. The B content (b) is, preferably, 0.150 or smaller and, more preferably, 0.120 or smaller.

When “b” is too small, a crystalline phase which is configured of crystals having a grain size of larger than 30 nm is likely to be formed in the soft magnetic alloy. When the crystalline phase is formed, it is not possible to deposit the Fe-based nanocrystals through the heat treatment. As a result, coercivity of the thermally treated soft magnetic alloy tends to easily increase. On the other hand, when “b” is too large, the saturation magnetization or the saturation magnetic flux density of the thermally treated soft magnetic alloy tends to easily decrease.

In the above-described composition formula, “c” represents a phosphorus (P) content, and “c” satisfies 0≤c≤0.150. The P content (c) is, preferably, 0.002 or larger and, more preferably, 0.010 or larger. In addition, the P content (c) is preferably 0.100 or smaller.

When “c” is within such a range described above, the specific resistance of the thermally treated soft magnetic alloy tends to improve, and the coercivity thereof tends to decrease. When “c” is too small, it is difficult to obtain such effects described above. On the other hand, when “c” is too large, the saturation magnetization or the saturation magnetic flux density of the thermally treated soft magnetic alloy tends to easily decrease.

In the above-described composition formula, “d” represents a silicon (Si) content, and “d” satisfies 0≤d≤0.175. The Si content (d) is, preferably, 0.001 or larger and, more preferably, 0.005 or larger. In addition, the Si content (d) is preferably 0.040 or smaller.

When “d” is within such a range described above, the coercivity of the thermally treated soft magnetic alloy tends to easily decrease. On the other hand, when “d” is too large, the coercivity of the thermally treated soft magnetic alloy tends to increase, conversely.

In the embodiment, P and/or Si is preferably contained. When both P and Si are not contained, particularly, the amorphous-forming ability is likely to deteriorate. Incidentally, containing P means that “c” is not 0, and “c” satisfies more preferably c≥0.001. Containing Si means that “d” is not 0, and “d” satisfies more preferably d≥0.0001.

In the above-described composition formula, “e” represents a carbon (C) content, and “e” satisfies 0≤e≤0.030. That is, C is an optional element. The C content (e) is preferably 0.001 or larger. In addition, the C content (e) is, preferably, 0.020 or smaller and, more preferably, 0.010 or smaller.

When “e” is within such a range described above, the coercivity of the thermally treated soft magnetic alloy tends to particularly easily decrease. When “e” is too large, conversely, the coercivity of the thermally treated soft magnetic alloy tends to increase.

In the above-described composition formula, “f” represents a sulfur (S) content, and “f” satisfies 0≤f≤0.010. That is, S is an optional element. The S content (f) is preferably 0.002 or larger. In addition, the S content (f) is preferably 0.010 or smaller.

When “f” is within such a range described above, the coercivity of the thermally treated soft magnetic alloy tends to easily decrease. When “f” is too large, conversely, the coercivity of the thermally treated soft magnetic alloy tends to increase.

In the above-described composition formula, “1−(a+b+c+d+e+f)” represents a total content ratio of Fe (iron), X1, and X2. The total content ratio of Fe, X1, and X2 is not particularly limited, as long as “a”, “b”, “c”, “d”, “e”, and “f” are contained within the ranges described above. In the embodiment, the total content ratio (1−(a+b+c+d+e+f)) is preferably 0.73 or higher and 0.91 or lower. The total content ratio is within such range described above, the crystalline phase which is configured of the crystals having a grain size of larger than 30 nm is unlikely to be formed. As a result, it is easy to obtain a soft magnetic alloy in which the Fe-based nanocrystals are deposited by the heat treatment.

X1 is at least one element selected from the group consisting of Co and Ni. In the above-described composition formula, “α” represents a content ratio of X1, and “α” is 0 or higher in the embodiment. That is, X1 is an optional element.

In addition, when the number of all atoms of the composition is 100 at %, the number of atoms of X1 is preferably 40 at % or smaller. That is, it is preferable to satisfy 0≤α{1−(a+b+c+d+e+f)}≤0.40.

X2 is at least one element selected from the group consisting of Al, Mn, Ag, Zn, Sn, As, Sb, Cu, Cr, Bi, N, O, and rare earth elements. In the above-described composition formula, “β” represents a content ratio of X2, and “β” is 0 or higher in the embodiment. That is, X2 is an optional element.

In addition, when the number of all atoms of the composition is 100 at %, the number of atoms of X2 is preferably 3.0 at % or smaller. That is, it is preferable to satisfy 0≤β{1−(a+b+c+d+e+f)}≤0.030.

Further, the range (substitution ratio) in which X1 and/or X2 substitutes for Fe is set equal to or less than half of the total number of Fe atoms in terms of the number of atoms. That is, 0≤α+β≤0.50 is satisfied. When α+β is too larger, it tends to be difficult to obtain a soft magnetic alloy in which the Fe-based nanocrystals are deposited by heat treatment.

Incidentally, the soft magnetic alloy according to the embodiment may contain additional elements as inevitable impurities. For example, a total of 0.1 mass % of the additional elements may be contained, based on 100 mass % of soft magnetic alloy.

2. Method for Manufacturing Soft Magnetic Alloy

Subsequently, a method for manufacturing the soft magnetic alloy described above will be described. In the embodiment, the method is not particularly limited, as long as an amorphous alloy is obtained in a method of rapidly cooling melted metal. For example, a ribbon of amorphous alloy may be obtained by a single-roll method, or powder of amorphous alloy may be obtained by an atomization method. Hereinafter, a method of obtaining the amorphous alloy by a gas-atomization method as an example of the atomization method.

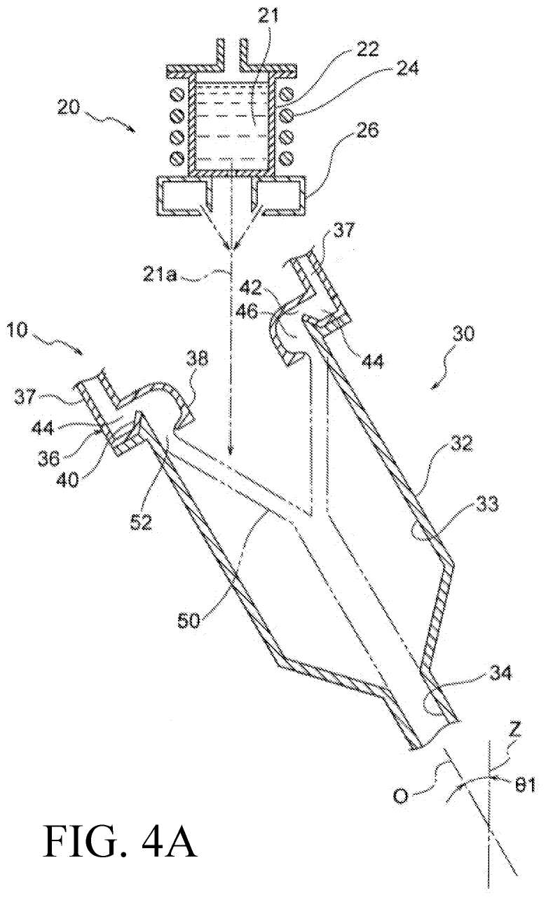

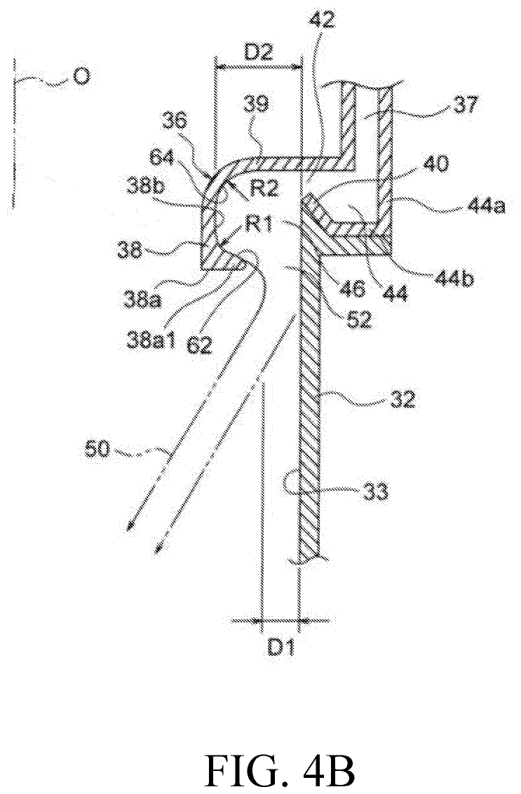

In the embodiment, in order to obtain an amorphous alloy having a glass transition temperature, it is preferable to obtain amorphous alloy powder by cooling melted metal by using an atomization apparatus illustrated in FIG. 4A.

As illustrated in FIG. 4A, an atomization apparatus 10 includes a melted-metal supply unit 20 and a cooling unit 30 which is disposed below the metal supply unit 20 in a vertical direction. In FIG. 4A, the vertical direction is a direction along a Z-axis.

The melted-metal supply unit 20 includes a heat-resistant container 22 that accommodates melted metal 21. Raw materials (pure metal or the like) of each metallic element are weighed to have a composition of the soft magnetic alloy which is finally obtained, and then in the heat-resistant container 22, raw materials are melted by a heating coil 24, and melted metal is obtained. A temperature during melting may be determined with consideration for a melting point of each metallic element; however, the temperature can be in a range of 1,200° C. to 1,500° C., for example.

The melted metal 21 is discharged as dripping melted metal 21a from a discharge port 23 toward the cooling unit 30. High-pressure gas is ejected from a gas ejecting nozzle 26 toward the discharged dripping melted metal 21a, and the dripping melted metal 21a becomes many droplets and is carried along with flow of the gas toward an inner surface of a cylindrical body 32.

As the gas which is ejected from the gas ejecting nozzle 26, it is preferable to use inert gas such as nitrogen gas, argon gas, helium gas or reducing gas such as ammonia decomposition gas, and air may be used when the melted metal 21 is metal which is unlikely to be oxidized.

The dripping melted metal 21a carried toward the inner surface of the cylindrical body 32 collides with a coolant flow 50 which is formed into an inverted conical shape inside the cylindrical body 32, is further cut and atomized and is cooled and solidified, and becomes solid alloy powder. An axial center O of the cylindrical body 32 is inclined with respect to a vertical line Z by a predetermined angle θ1. The predetermined angle θ1 is not particularly limited; however, the predetermined angle is preferably 0 to 45 degrees. Within such an angle range described above, the dripping melted metal 21a from the discharge port 23 is easily discharged toward the coolant flow 50 which is formed into the inverted conical shape inside the cylindrical body 32.

A discharge unit 34 is provided below along the axial center O of the cylindrical body 32, and alloy powder which is contained in the coolant flow 50 can be discharged outside. The alloy powder discharged together with a coolant is separated from the coolant to be retrieved in an external storage tank or the like. Incidentally, the coolant is not particularly limited, and cooling water is used.

In the embodiment, since the dripping melted metal 21a collides with the coolant flow 50 which is formed into the inverted conical shape, a flying time of droplets of the dripping melted metal 21a is shortened, compared to a case where the coolant flow is formed along an inner surface 33 of the cylindrical body 32. When the flying time is shortened, a rapid cooling effect is promoted, and an amorphous phase ratio of obtained alloy powder improves. As a result, an amorphous alloy having the glass transition temperature is easily obtained. In addition, when the flying time is shortened, the droplets of the dripping melted metal 21a are unlikely to be oxidized. Thus, atomization of the obtained alloy powder is promoted, and quality of the alloy powder also improves.

In the embodiment, in order to form the coolant flow into the inverted conical shape inside the cylindrical body 32, flowing of a coolant in a coolant introducing unit (coolant guiding unit) 36 for introducing the coolant inside the cylindrical body 32 is controlled. FIG. 4B illustrates a configuration of the coolant introducing unit 36.

As illustrated in FIG. 4B, a frame body 38 demarcates an outer portion (outer space) 44 which is positioned on an outer side of the cylindrical body 32 in a radial direction and an inner portion (inner space) 46 which is positioned on an inner side of the cylindrical body 32 in the radial direction. The outer portion 44 and the inner portion 46 are partitioned by a partition 40, and a passage 42 which is formed on an upper side from the partition 40 in a direction of the axial center O allows the outer portion 44 and the inner portion 46 to communicate with each other such that the coolant can flow.

A single or a plurality of nozzles 37 are connected to the outer portion 44, and thus the coolant can enter the outer portion 44 from the nozzle 37. In addition, a coolant discharging portion 52 is formed at a lower side from the inner portion 46 in the direction of the axial center O, and the coolant in the inner portion 46 can be discharged (guided) from the coolant discharging portion to the inside of the cylindrical body 32.

An outer peripheral surface of the frame body 38 functions as a flow-channel inner peripheral surface 38b that guides the flow of the coolant in the inner portion 46, and a lower end 38a of the frame body 38 has an outward projection portion 38a1 which is continuous from the flow-channel inner peripheral surface 38b of the frame body 38 and projects outward in the radial direction. Hence, a ring-shaped gap between a tip of the outward projection portion 38a1 and the inner surface 33 of the cylindrical body 32 functions as the coolant discharging portion 52. A flow-channel inclined surface 62 is formed on a flow-channel side top surface of the outward projection portion 38a1.

As illustrated in FIG. 4B, the outward projection portion 38a1 causes a radial-direction width D1 of the coolant discharging portion 52 to be narrower than a radial-direction width D2 thereof at a main part of the inner portion 46. D1 is narrower than D2, and thereby the coolant flowing go down along the flow-channel inner peripheral surface 38b toward a lower side of the axial center O inside the inner portion 46 and then flows along the flow-channel inclined surface 62 of the frame body 38 to collide with and be reflected from the inner surface 33 of the cylindrical body 32. As a result, as illustrated in FIG. 4A, the coolant is discharged in an inverted conical shape from the coolant discharging portion 52 to the inside of the cylindrical body 32 such that the coolant flow 50 is formed. Incidentally, when D1=D2, the coolant which is discharged from the coolant discharging portion 52 forms a coolant flow along the inner surface 33 of the cylindrical body 32.

Here, D1/D2 is preferably ⅔ or smaller, more preferably ½ or smaller, and preferably, 1/10 or larger.

Incidentally, the coolant flow 50 flowing from the coolant discharging portion 52 is an inverted conical flow which flows straight from the coolant discharging portion 52 toward the axial center O; however, the coolant flow may be an inverted conical flow having a helical shape.

In addition, a gas ejecting temperature, a gas ejecting pressure, a pressure in the cylindrical body 32, or the like may be determined depending on a condition in which the Fe-based nanocrystals are easily deposited in the amorphous, during a heat treatment to be described below. Incidentally, a particle diameter can be adjusted by sieve classification, airflow classification, or the like.

Next, a method for obtaining the ribbon of soft magnetic alloy according to the embodiment by the single-roll method will be described.

Similar to the atomization method, first, melted metal containing melted raw materials of the soft magnetic alloy is obtained. Next, the obtained melted metal is ejected and supplied from the nozzle to a cooled rotary roll inside a chamber filled with inert gas, for example, and thereby a ribbon or a flake is manufactured in a rotational direction of the rotary roll. An example of a material of the rotary roll includes copper.

In order to obtain an amorphous alloy having the glass transition temperature, for example, surface roughness of the rotary roll can be reduced, an ejection pressure of the melted metal can increase, and a supply amount of the melted metal can be reduced.

In addition, a temperature of the rotary roll, a rotational speed of the rotary roll, an atmosphere inside the chamber, or the like may be determined depending on a condition in which the Fe-based nanocrystals are easily deposited in the amorphous, during the heat treatment to be described below.

Powder-shaped soft magnetic alloy and ribbon-shaped soft magnetic alloy which are obtained by the above-described methods is configured of an amorphous alloy. The amorphous alloy may be an alloy having the amorphous phase.

In the embodiment, whether or not the alloy has the amorphous phase can be evaluated by calculating the amorphous phase ratio described above. Incidentally, in a case where the soft magnetic alloy has the ribbon shape, an average value of an amorphous phase ratio X_{A} at a surface which is in contact with a roll surface and an amorphous phase ratio X_{B} at a surface which is not in contact with the roll surface is set as the amorphous phase ratio X. The alloy having the amorphous phase may be an alloy containing crystals in the amorphous or may be an alloy which does not contain crystals in the amorphous.

In addition, the alloy having the amorphous phase is preferably an alloy having a nanoheterostructure in which initial fine crystals are present in the amorphous phase or an alloy which is configured only of the amorphous. An average crystal grain size of the initial fine crystals is preferably 0.3 nm or larger and 10 nm or smaller.

A method for observing presence or absence of the initial fine crystals and the average crystal grain size is not particularly limited, and evaluation may be performed by a known method. For example, a bright-field image or a high-resolution image of a sample flaked through ion milling is obtained using a transmission electron microscope (TEM), and thereby verification can be achieved. Specifically, a bright-field image or a high-resolution image which is obtained under magnification of 1.00×10⁵ to 3.00×10⁵ times is visually observed, and thereby presence or absence of the initial microcrystal and the average crystal grain size can be evaluated.

Next, the obtained powder-shaped soft magnetic alloy and ribbon-shaped soft magnetic alloy are subjected to the heat treatment. By the heat treatment, it is easy to obtain the soft magnetic alloy in which the Fe-based nanocrystals are deposited.

In the embodiment, a heat-treatment condition is not particularly limited, as long as the Fe-based nanocrystals are deposited under the condition. For example, regardless of shapes (ribbon shape, powder shape, and the like) of the soft magnetic alloy according to the embodiment, a heat-treatment temperature can be set from 400° C. to 650° C., and a holding time can be set from 0.1 to 10 hours.

After the heat treatment, the powder-shaped soft magnetic alloy in which the Fe-based nanocrystals are deposited or the ribbon-shaped soft magnetic alloy in which the Fe-based nanocrystals are deposited is obtained.

3. Magnetic Part

A magnetic part according to the embodiment is not particularly limited, as long as the magnetic part contains the above-described soft magnetic alloy as a magnetic material. For example, the magnetic part may have a magnetic core which is configured of the above-described soft magnetic alloy.

An example of a method for obtaining a magnetic core from the ribbon-shaped soft magnetic alloy includes a method for winding the ribbon-shaped soft magnetic alloy or a method for stacking the ribbon-shaped soft magnetic alloys. In a case where stacking is performed via an insulation body when the ribbon-shaped soft magnetic alloys are stacked, it is possible to obtain a magnetic core that further improves a property thereof.

An example of a method for obtaining a magnetic core from the powder-shaped soft magnetic alloy includes a method for performing molding using a die, after the soft magnetic alloy is mixed with an appropriate binder. In addition, before the binder is mixed, powder surfaces are subjected to an oxidation treatment, insulation coating, or the like, and thereby specific resistance improves such that a magnetic core suitable for a higher frequency band is obtained.

The magnetic part obtained in such a manner described above is subjected to the heat treatment, and thereby a magnetic part having the soft magnetic alloy having the Fe-based nanocrystals as the main magnetic material is manufactured or further, soft magnetic powder may be subjected to the heat treatment before the magnetic part is manufactured.

As described above, the embodiment of the invention is described; however, the invention is not limited to the embodiment described above at all, and the invention may be modified to various aspects within a scope of the invention.

### Examples

Hereinafter, the invention will be described in detail using Examples, but the invention is not limited to the Examples.

Sample Number 1a

First, raw material metals of a soft magnetic alloy were prepared. The prepared raw material metals were weighed to have a composition illustrated in Table 1 and were accommodated in the heat-resistant container 22 disposed in the atomization apparatus 10 illustrated in FIGS. 4A and 4B. Subsequently, after the inside of the cylindrical body 32 was evacuated, the heat-resistant container 22 was heated by high frequency induction using the heating coil 24 provided outside the heat-resistant container 22, and the raw material metals in the heat-resistant container 22 were melted and mixed to obtain melted metal having a temperature of 1,500° C.

The obtained melted metal was ejected into the cylindrical body 32 of the cooling unit 30 at 1,500° C. and the argon gas was ejected at the gap pressure of 5 MPa, and thereby many droplets were formed. The droplets collided with the coolant flow having the inverted conical shape formed by the coolant water supplied at a pump pressure of 7.5 MPa to become fine powder, and then the fine powder was collected.

In the apparatus 10 illustrated in FIGS. 4A and 4B, an inner diameter of the inner surface of the cylindrical body 32 was 300 mm, D1/D2 was ½, and the angle θ1 was 20 degrees.

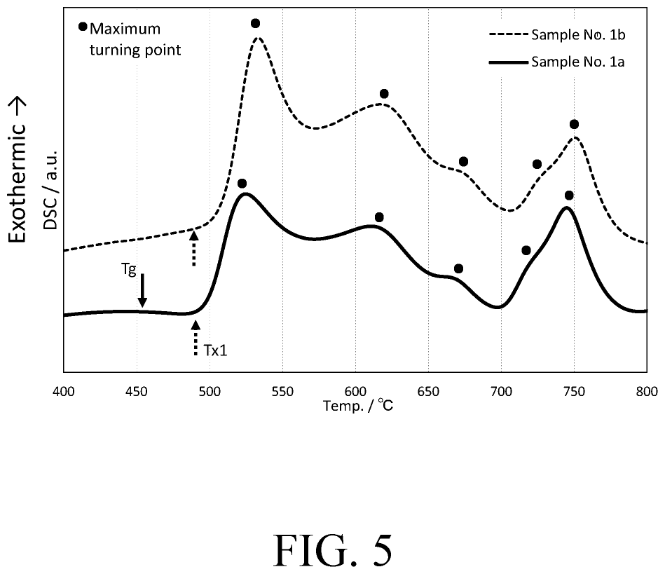

The obtained powder was subjected to differential scanning calorimetry measurement at a temperature rising rate of 40 K/min, and the differential scanning calorimetry curve was obtained. The obtained differential scanning calorimetry curve is illustrated in FIG. 5. The number of exothermic peaks in a range from 350° C. to 850° C. was calculated from the number of the maximum turning points of a differential curve of the differential scanning calorimetry curve. In addition, on a temperature side lower than the first exothermic peak, whether or not the glass transition temperature was present in a range from 350° C. to 600° C. was determined from a differential value at each temperature. Results are illustrated in Table 1.

The obtained powder was subjected to the X-ray crystal structure analysis by the XRD and the phase identification. Specifically, the peaks (Ic: scattering integral intensity originated from crystal and Ia: scattering integral intensity originated from amorphous) of crystallized Fe or compound were read, a crystallization rate was determined from peak intensity of the peaks, and the amorphous phase ratio X was calculated by Expression (1). In the example, a powder X-ray analyzing method was used.

X=100−(Ic/(Ic+Ia)×100) Expression (1)

Ic: Scattering Integral Intensity originated from crystal
Ia: Scattering Integral Intensity originated from amorphous

In the embodiment, a sample having the calculated amorphous phase ratio X of 85% or higher was determined that the soft magnetic alloy was configured of an alloy having the amorphous phase, and a sample having the calculated amorphous phase ratio X of lower than 85% was determined that the soft magnetic alloy was configured of the crystalline phase. Results are illustrated in Table 1.

In addition, in a case where the soft magnetic alloy was configured of the alloy having the amorphous phase, the presence or absence of the initial fine crystals was evaluated by the transmission electron microscope. Results are illustrated in Table 1.

In addition, the obtained powder was subjected to the heat treatment. In the heat-treatment condition, the temperature rising rate was 5 K/min, the heat-treatment temperature was 600° C., and the holding time was one hour. The thermally treated powder was observed by the X-ray diffraction measurement and TEM, and it was confirmed that the Fe-based nanocrystal having the bcc structure was present. Incidentally, the average crystal grain size of the Fe-based nanocrystal was 5 nm to 30 nm.

The coercivity (Hc) and the saturation magnetic flux density (Bs) of the thermally treated powder were measured. The powder and paraffin were put by 20 mg in a plastic case having a size of ϕ 6 mm×5 mm, and the paraffin was melted and solidified such that the powder was fixed, and the coercivity thereof was measured using a coercive force meter (K-HC1000) manufactured by TOHOKU STEEL Co., Ltd.). A measurement magnetic field was 150 kA/m. In the example, a sample having the coercivity of 5.0 [Oe] or lower was determined to be good. Results are illustrated in Table 1. The saturation magnetic flux density was measured using a vibrating sample magnetometer (VSM) manufactured by TAMAKAWA Co., Ltd. In the example, a sample having the saturation magnetic flux density of 1.30 [T] or higher was determined to be good. Results are illustrated in Table 1.

Sample Number 1b

Powder was manufactured similarly to the sample number 1a using the same atomization apparatus as in the sample number 1a except that the atomization apparatus did not have an outward projection portion having the flow-channel inclined surface 62 at the lower end 38a of the frame body 38, and D1=D2 (dimension of D1 being equal to that in the sample number 1a). Incidentally, the coolant flow 50 was a flow along the inner peripheral surface of the cylindrical body 32.

The obtained powder was subjected to the same measurement as that in the sample number 1a to obtain the differential scanning calorimetry curve. The obtained differential scanning calorimetry curve is illustrated in FIG. 5. In addition, the obtained powder was subjected to the heat treatment with the same condition as that of the sample number 1 a, and the same evaluation as that in the sample number 1a was performed on the thermally treated powder. Results are illustrated in Table 1.

Sample Number 1c

The powder was manufactured in the same manner as in the sample number 1a except that a temperature of the melted metal which was ejected into the cylindrical body 32 was 1,550° C. Similar to the sample number 1a, a degree of the amorphous of the obtained powder was evaluated, the presence or absence of the initial fine crystals and the glass transition temperature Tg was determined, and the number of exothermic peaks was calculated from the differential scanning calorimetry curve. In addition, the obtained powder was subjected to the heat treatment with the same condition as that of the sample number 1a, and the same evaluation as that in the sample number 1a was performed on the thermally treated powder. Results are illustrated in Table 1.

Sample Number 1d

The powder was manufactured in the same manner as in the sample number 1b except that a temperature of the melted metal which was ejected into the cylindrical body 32 was 1,550° C. The obtained powder was evaluated in the same manner as that in the sample number 1c. Results are illustrated in Table 1.

TABLE 1

| | | Method for | | | | | | | | | | | |
|---|---|---|---|---|---|---|---|---|---|---|---|---|---|
| | | manufac- | | Fe_{1-a-b-c-d-e-f}NbₐB_{b}P_{c} | | | | | | | | | |
| | | turing | Melted | α = β = 0 d = e = f = 0 | | | | | Degree | Presence | | | |
| Compar- | | powder | metal | Fe | | | | | of the | or absence | Number | Magnetic | |
| ative | | Outward | ejecting | 1 − a − b − | | | | Presence | amorphous | of initial | of exo- | properties | |
| example/ | Sample | projection | temper- | c − d − e − | M:Nb | B | P | or absence | before heat | fine | thermic | Hc/Oe | Bs/T |
| Example | number | portion | ature | f | a | b | c | of Tg | treatment | crystals | peaks | 5 K/min | 5 K/min |
| Example | 1a | Formed | 1500° C. | 0.810 | 0.070 | 0.090 | 0.030 | Present | Amorphous | Absent | 5 | 0.77 | 1.48 |
| | | | | | | | | | phase | | | | |
| Compar- | 1b | Non-formed | 1500° C. | 0.810 | 0.070 | 0.090 | 0.030 | Absent | Amorphous | Absent | 5 | 5.6 | 1.48 |
| ative | | | | | | | | | phase | | | | |
| example | | | | | | | | | | | | | |
| Example | 1c | Formed | 1550° C. | 0.810 | 0.070 | 0.090 | 0.030 | Present | Amorphous | Present | 5 | 0.89 | 1.48 |
| | | | | | | | | | phase | | | | |
| Compar- | 1d | Non-formed | 1550° C. | 0.810 | 0.070 | 0.090 | 0.030 | Absent | Amorphous | Present | 5 | 6.2 | 1.48 |
| ative | | | | | | | | | phase | | | | |
| example | | | | | | | | | | | | | |

From Table 1, it was confirmed that both the soft magnetic alloy according to the sample number 1a and the soft magnetic alloy according to the sample number 1b were alloys configured only of the amorphous which did not have the initial fine crystals. On the other hand, from FIG. 5, it was confirmed that the soft magnetic alloy according to the sample number 1a had the glass transition temperature, whereas the soft magnetic alloy according to the sample number 1b did not have the glass transition temperature. In addition, it was confirmed that the coercivity of the soft magnetic alloy according to the sample number 1a was smaller than the coercivity of the soft magnetic alloy according to the sample number 1b. In the sample number 1a, it is considered that the amorphous phase is stable, and the grain growth of the Fe-based nanocrystal was suppressed even when the temperature rising rate during the heat treatment was low and thus the coercivity was considered to increase.

In addition, from Table 1, it was confirmed that both the soft magnetic alloy according to the sample number 1c and the soft magnetic alloy according to the sample number 1d were alloys having the initial fine crystals in the amorphous phase. On the other hand, since the soft magnetic alloy according to the sample number Ic had the glass transition temperature, it was confirmed that the soft magnetic alloy according to the sample number 1d which did not have the glass transition temperature had the coercivity lower than that of the soft magnetic alloy according to the sample number 1d.

Sample Numbers 2 to 52

Powder was manufactured by the same method of the sample number 1a except that the composition of the soft magnetic alloy was compositions illustrated in Table 2, and the manufactured powder was evaluated in the same manner as that in the sample number 1a. Results are illustrated in Table 2.

TABLE 2

| | | Method for | | | | | | | | | | | | |
|---|---|---|---|---|---|---|---|---|---|---|---|---|---|---|
| | | manufac- | Fe_{1-a-b-c-d-e-f}NbₐB_{b}P_{c}Si_{d}CₑS_{f} | | | | | | | | | | | |
| | | turing | α = β = 0 | | | | | | | | | | | |
| Compar- | Sam- | powder | Fe | | | | | | | | Degree of | Number | Magnetic | |
| ative | ple | Outward | 1 − a − b − | | | | | | | Presence | amorphous | of exo- | properties | |
| example/ | num- | projection | c − d − e − | M:Nb | B | P | Si | C | S | or absence | before heat | thermic | Hc/Oe | Bs/T |
| example | ber | portion | f | a | b | c | d | e | f | of Tg | treatment | peaks | 5 K/min | 5 K/min |
| Compar- | 1b | Non-formed | 0.810 | 0.070 | 0.090 | 0.030 | 0.000 | 0.000 | 0.000 | Abscent | Amorphous phase | 5 | 5.6 | 1.48 |
| ative | | | | | | | | | | | | | | |
| example | | | | | | | | | | | | | | |
| Example | 2 | Formed | 0.809 | 0.070 | 0.090 | 0.030 | 0.001 | 0.000 | 0.000 | Present | Amorphous phase | 5 | 0.94 | 1.50 |
| Example | 3 | Formed | 0.800 | 0.070 | 0.090 | 0.030 | 0.010 | 0.000 | 0.000 | Present | Amorphous phase | 5 | 0.31 | 1.48 |
| Example | 4 | Formed | 0.760 | 0.070 | 0.090 | 0.030 | 0.050 | 0.000 | 0.000 | Present | Amorphous phase | 5 | 0.70 | 1.41 |
| Example | 5 | Formed | 0.710 | 0.070 | 0.090 | 0.030 | 0.100 | 0.000 | 0.000 | Present | Amorphous phase | 4 | 2.16 | 1.37 |
| Example | 6 | Formed | 0.660 | 0.070 | 0.090 | 0.030 | 0.150 | 0.000 | 0.000 | Present | Amorphous phase | 4 | 1.13 | 1.38 |
| Example | 7 | Formed | 0.640 | 0.070 | 0.090 | 0.030 | 0.170 | 0.000 | 0.000 | Present | Amorphous phase | 3 | 2.88 | 1.39 |
| Example | 8 | Formed | 0.630 | 0.070 | 0.090 | 0.030 | 0.180 | 0.000 | 0.000 | Present | Amorphous phase | 3 | 4.11 | 1.32 |
| Compar- | 9 | Formed | 0.610 | 0.070 | 0.090 | 0.030 | 0.200 | 0.000 | 0.000 | Present | Amorphous phase | 2 | 183 | 1.24 |
| ative | | | | | | | | | | | | | | |
| example | | | | | | | | | | | | | | |
| Example | 10 | Formed | 0.790 | 0.070 | 0.100 | 0.030 | 0.010 | 0.000 | 0.000 | Present | Amorphous phase | 5 | 0.75 | 1.40 |
| Example | 11 | Formed | 0.740 | 0.070 | 0.150 | 0.030 | 0.010 | 0.000 | 0.000 | Present | Amorphous phase | 5 | 0.33 | 1.51 |
| Example | 12 | Formed | 0.690 | 0.070 | 0.200 | 0.030 | 0.010 | 0.000 | 0.000 | Present | Amorphous phase | 6 | 1.80 | 1.35 |
| Example | 13 | Formed | 0.810 | 0.060 | 0.090 | 0.030 | 0.010 | 0.000 | 0.000 | Present | Amorphous phase | 4 | 0.98 | 1.49 |
| Example | 14 | Formed | 0.770 | 0.060 | 0.090 | 0.030 | 0.050 | 0.000 | 0.000 | Present | Amorphous phase | 3 | 0.87 | 1.50 |
| Example | 15 | Formed | 0.720 | 0.060 | 0.090 | 0.030 | 0.100 | 0.000 | 0.000 | Present | Amorphous phase | 3 | 2.19 | 1.36 |
| Example | 16 | Formed | 0.809 | 0.070 | 0.090 | 0.030 | 0.000 | 0.001 | 0.000 | Present | Amorphous phase | 5 | 0.33 | 1.45 |
| Example | 17 | Formed | 0.808 | 0.070 | 0.090 | 0.030 | 0.000 | 0.002 | 0.000 | Present | Amorphous phase | 5 | 0.73 | 1.45 |
| Example | 18 | Formed | 0.805 | 0.070 | 0.090 | 0.030 | 0.000 | 0.005 | 0.000 | Present | Amorphous phase | 5 | 0.49 | 1.45 |
| Example | 19 | Formed | 0.800 | 0.070 | 0.090 | 0.030 | 0.000 | 0.010 | 0.000 | Present | Amorphous phase | 5 | 0.56 | 1.51 |
| Example | 20 | Formed | 0.790 | 0.070 | 0.090 | 0.030 | 0.000 | 0.020 | 0.000 | Present | Amorphous phase | 5 | 0.69 | 1.47 |
| Example | 21 | Formed | 0.780 | 0.070 | 0.090 | 0.030 | 0.000 | 0.030 | 0.000 | Present | Amorphous phase | 6 | 0.69 | 1.43 |
| Example | 22 | Formed | 0.770 | 0.070 | 0.090 | 0.030 | 0.000 | 0.040 | 0.000 | Present | Amorphous phase | 6 | 3.17 | 1.32 |
| Compar- | 23 | Formed | 0.760 | 0.070 | 0.090 | 0.030 | 0.000 | 0.050 | 0.000 | Abscent | Crystalline | 6 | 128 | 1.36 |
| ative | | | | | | | | | | | phase | | | |
| example | | | | | | | | | | | | | | |
| Compar- | 24 | Formed | 0.840 | 0.070 | 0.090 | 0.000 | 0.000 | 0.000 | 0.000 | Abscent | Crystalline | 3 | 160 | 1.52 |
| ative | | | | | | | | | | | phase | | | |
| example | | | | | | | | | | | | | | |
| Example | 25 | Formed | 0.830 | 0.070 | 0.090 | 0.010 | 0.000 | 0.000 | 0.000 | Present | Amorphous phase | 5 | 0.71 | 1.49 |
| Example | 26 | Formed | 0.820 | 0.070 | 0.090 | 0.020 | 0.000 | 0.000 | 0.000 | Present | Amorphous phase | 5 | 0.60 | 1.42 |
| Example | 27 | Formed | 0.810 | 0.070 | 0.090 | 0.030 | 0.000 | 0.000 | 0.000 | Present | Amorphous phase | 5 | 0.77 | 1.48 |
| Example | 28 | Formed | 0.800 | 0.070 | 0.090 | 0.040 | 0.000 | 0.000 | 0.000 | Present | Amorphous phase | 4 | 0.82 | 1.45 |
| Example | 29 | Formed | 0.790 | 0.070 | 0.090 | 0.050 | 0.000 | 0.000 | 0.000 | Present | Amorphous phase | 4 | 0.65 | 1.46 |
| Example | 30 | Formed | 0.740 | 0.070 | 0.090 | 0.100 | 0.000 | 0.000 | 0.000 | Present | Amorphous phase | 3 | 0.69 | 1.50 |
| Example | 31 | Formed | 0.690 | 0.070 | 0.090 | 0.150 | 0.000 | 0.000 | 0.000 | Present | Amorphous phase | 3 | 1.04 | 1.36 |
| Example | 32 | Formed | 0.640 | 0.070 | 0.090 | 0.200 | 0.000 | 0.000 | 0.000 | Present | Amorphous phase | 3 | 3.33 | 1.31 |
| Compar- | 33 | Formed | 0.900 | 0.070 | 0.000 | 0.030 | 0.000 | 0.000 | 0.000 | Abscent | Crystalline | 2 | 118 | 1.49 |
| ative | | | | | | | | | | | phase | | | |
| example | | | | | | | | | | | | | | |
| Example | 34 | Formed | 0.850 | 0.070 | 0.050 | 0.030 | 0.000 | 0.000 | 0.000 | Present | Amorphous phase | 4 | 0.80 | 1.50 |
| Example | 35 | Formed | 0.830 | 0.070 | 0.070 | 0.030 | 0.000 | 0.000 | 0.000 | Present | Amorphous phase | 4 | 0.85 | 1.50 |
| Example | 36 | Formed | 0.810 | 0.070 | 0.090 | 0.030 | 0.000 | 0.000 | 0.000 | Present | Amorphous phase | 5 | 0.74 | 1.48 |
| Example | 37 | Formed | 0.800 | 0.070 | 0.100 | 0.030 | 0.000 | 0.000 | 0.000 | Present | Amorphous phase | 5 | 0.99 | 1.41 |
| Example | 38 | Formed | 0.750 | 0.070 | 0.150 | 0.030 | 0.000 | 0.000 | 0.000 | Present | Amorphous phase | 5 | 0.87 | 1.50 |
| Example | 39 | Formed | 0.720 | 0.070 | 0.180 | 0.030 | 0.000 | 0.000 | 0.000 | Present | Amorphous phase | 6 | 2.80 | 1.35 |
| Example | 40 | Formed | 0.700 | 0.070 | 0.200 | 0.030 | 0.000 | 0.000 | 0.000 | Present | Amorphous phase | 6 | 2.23 | 1.36 |
| Example | 41 | Formed | 0.690 | 0.070 | 0.210 | 0.030 | 0.000 | 0.000 | 0.000 | Present | Amorphous phase | 6 | 4.49 | 1.31 |
| Example | 42 | Formed | 0.809 | 0.070 | 0.090 | 0.030 | 0.000 | 0.000 | 0.001 | Present | Amorphous phase | 5 | 0.59 | 1.49 |
| Example | 43 | Formed | 0.808 | 0.070 | 0.090 | 0.030 | 0.000 | 0.000 | 0.002 | Present | Amorphous phase | 5 | 0.83 | 1.51 |
| Example | 44 | Formed | 0.805 | 0.070 | 0.090 | 0.030 | 0.000 | 0.000 | 0.005 | Present | Amorphous phase | 6 | 0.59 | 1.43 |
| Example | 45 | Formed | 0.800 | 0.070 | 0.090 | 0.030 | 0.000 | 0.000 | 0.010 | Present | Amorphous phase | 7 | 0.89 | 1.46 |
| Example | 46 | Formed | 0.795 | 0.070 | 0.090 | 0.030 | 0.000 | 0.000 | 0.015 | Present | Amorphous phase | 7 | 3.50 | 1.30 |
| Example | 47 | Formed | 0.790 | 0.070 | 0.090 | 0.030 | 0.000 | 0.000 | 0.020 | Abscent | Crystalline | 7 | 145 | 1.42 |
| | | | | | | | | | | | phase | | | |
| Example | 48 | Formed | 0.830 | 0.010 | 0.090 | 0.030 | 0.040 | 0.000 | 0.000 | Present | Amorphous phase | 3 | 0.96 | 1.43 |
| Example | 49 | Formed | 0.810 | 0.030 | 0.090 | 0.030 | 0.040 | 0.000 | 0.000 | Present | Amorphous phase | 3 | 0.94 | 1.48 |
| Example | 50 | Formed | 0.770 | 0.070 | 0.090 | 0.030 | 0.040 | 0.000 | 0.000 | Present | Amorphous phase | 4 | 0.85 | 1.48 |
| Example | 51 | Formed | 0.750 | 0.090 | 0.090 | 0.030 | 0.040 | 0.000 | 0.000 | Present | Amorphous phase | 6 | 0.88 | 1.41 |
| Example | 52 | Formed | 0.690 | 0.150 | 0.090 | 0.030 | 0.040 | 0.000 | 0.000 | Present | Amorphous phase | 6 | 3.8 | 1.33 |

From Table 2, it was confirmed that the coercivity tends to increase when the number of exothermic peaks of the soft magnetic alloy is small. In addition, it was confirmed that the coercivity tends to increase even in a case where the soft magnetic alloy does not have the glass transition temperature.

Sample Numbers 53 to 62

In regard to sample number 27, powder was manufactured by the same method of the sample number 27 except that M in the composition formula was an element illustrated in Table 3, and the manufactured powder was evaluated in the same manner as that in the sample number 27. Results are illustrated in Table 3.

TABLE 3

| | | Method for | | | | | | |
|---|---|---|---|---|---|---|---|---|
| | | manufacturing | | | | | | |
| | | powder | | | | | | |
| Comparative | | Outward | Fe_{0.810}M_{0.070}B_{0.090}P_{0.030} | Presence | Degree of | Number of | Magnetic properties | |
| example/ | Sample | projection | α = β = 0 | or absence | amorphous before | exothermic | Hc/Oe | Bs/T |
| example | number | portion | M | of Tg | heat treatment | peaks | 5 K/min | 5 K/min |
| Example | 27 | Formed | Nb | Present | Amorphous phase | 5 | 0.77 | 1.48 |
| Example | 53 | Formed | Hf | Present | Amorphous phase | 5 | 0.81 | 1.60 |
| Example | 54 | Formed | Zr | Present | Amorphous phase | 5 | 0.79 | 1.72 |
| Example | 55 | Formed | Ta | Present | Amorphous phase | 5 | 0.76 | 1.46 |
| Example | 56 | Formed | Mo | Present | Amorphous phase | 5 | 0.79 | 1.43 |
| Example | 57 | Formed | W | Present | Amorphous phase | 5 | 0.81 | 1.44 |
| Example | 58 | Formed | V | Present | Amorphous phase | 5 | 0.81 | 1.52 |
| Example | 59 | Formed | Ti | Present | Amorphous phase | 5 | 0.87 | 1.51 |
| Example | 60 | Formed | Nb_{0.5}Hf_{0.5} | Present | Amorphous phase | 5 | 0.78 | 1.54 |
| Example | 61 | Formed | Zr_{0.5}Ta_{0.5} | Present | Amorphous phase | 5 | 0.74 | 1.65 |
| Example | 62 | Formed | Nb_{0.4}Hf_{0.3}Zr_{0.3} | Present | Amorphous phase | 5 | 0.76 | 1.62 |

From Table 3, in a case where the soft magnetic alloy had the glass transition temperature, and the number of exothermic peaks was within the above-described range, it was confirmed that good properties were obtained regardless of M.

Sample Numbers 63 to 116

In regard to sample number 27, powder was manufactured by the same method of the sample number 27 except that X1 and X2 in the composition formula are elements and contain ratios illustrated in Table 4, and the manufactured powder was evaluated in the same manner as that in the sample number 27. Results are shown in Table 4.

TABLE 4

| | | Method for | (Fe_{(1-a-b)}X1ₐX2_{b})_{0.810}M_{0.070}B_{0.090}P_{0.030} | | | | | | | | |
|---|---|---|---|---|---|---|---|---|---|---|---|
| | | manufacturing | X1 (atomic ratio) | | X2 (atomic ratio) | | | | | | |
| | | powder | | a{1 − | | b{1 − | | Degree of | | Magnetic | |
| Comparative | | Outward | | (a + b + | | (a + b + | Presence | amorphous | number of | properties | |
| example/ | Sample | projection | | c + d + | | c + d + | or absence | before heat | exothermic | Hc/Oe | Bs/T |
| example | number | portion | Element | e + f)} | Element | e + f)} | of Tg | treatment | peaks | 5 K/min | 5 K/min |
| Example | 27 | Formed | — | 0.0000 | — | 0.0000 | Present | Amorphous phase | 5 | 0.77 | 1.48 |
| Example | 63 | Formed | Co | 0.0100 | — | 0.0000 | Present | Amorphous phase | 5 | 0.92 | 1.51 |
| Example | 64 | Formed | Co | 0.1000 | — | 0.0000 | Present | Amorphous phase | 4 | 1.03 | 1.62 |
| Example | 65 | Formed | Co | 0.4000 | — | 0.0000 | Present | Amorphous phase | 3 | 1.25 | 1.70 |
| Example | 66 | Formed | Ni | 0.0100 | — | 0.0000 | Present | Amorphous phase | 5 | 0.77 | 1.43 |
| Example | 67 | Formed | Ni | 0.1000 | — | 0.0000 | Present | Amorphous phase | 5 | 0.73 | 1.35 |
| Example | 68 | Formed | Ni | 0.4000 | — | 0.0000 | Present | Amorphous phase | 5 | 0.70 | 1.20 |
| Example | 69 | Formed | — | 0.0000 | Al | 0.0010 | Present | Amorphous phase | 5 | 0.66 | 1.47 |
| Example | 70 | Formed | — | 0.0000 | Al | 0.0050 | Present | Amorphous phase | 5 | 0.77 | 1.43 |
| Example | 71 | Formed | — | 0.0000 | Al | 0.0100 | Present | Amorphous phase | 5 | 0.73 | 1.38 |
| Example | 72 | Formed | — | 0.0000 | Al | 0.0300 | Present | Amorphous phase | 5 | 0.77 | 1.35 |
| Example | 73 | Formed | — | 0.0000 | Zn | 0.0010 | Present | Amorphous phase | 5 | 0.81 | 1.47 |
| Example | 74 | Formed | — | 0.0000 | Zn | 0.0050 | Present | Amorphous phase | 5 | 0.81 | 1.47 |
| Example | 75 | Formed | — | 0.0000 | Zn | 0.0100 | Present | Amorphous phase | 5 | 0.77 | 1.30 |
| Example | 76 | Formed | — | 0.0000 | Zn | 0.0300 | Present | Amorphous phase | 5 | 0.81 | 1.23 |
| Example | 77 | Formed | — | 0.0000 | Sn | 0.0010 | Present | Amorphous phase | 5 | 0.76 | 1.47 |
| Example | 78 | Formed | — | 0.0000 | Sn | 0.0050 | Present | Amorphous phase | 5 | 0.75 | 1.45 |
| Example | 79 | Formed | — | 0.0000 | Sn | 0.0100 | Present | Amorphous phase | 5 | 0.76 | 1.34 |
| Example | 80 | Formed | — | 0.0000 | Sn | 0.0300 | Present | Amorphous phase | 5 | 0.78 | 1.36 |
| Example | 81 | Formed | — | 0.0000 | Cu | 0.0010 | Present | Amorphous phase | 5 | 0.70 | 1.48 |
| Example | 82 | Formed | — | 0.0000 | Cu | 0.0050 | Present | Amorphous phase | 5 | 0.70 | 1.46 |
| Example | 83 | Formed | — | 0.0000 | Cu | 0.0100 | Present | Amorphous phase | 6 | 0.66 | 1.47 |
| Example | 84 | Formed | — | 0.0000 | Cu | 0.0300 | Present | Amorphous phase | 6 | 0.70 | 1.32 |
| Example | 85 | Formed | — | 0.0000 | Cr | 0.0010 | Present | Amorphous phase | 5 | 0.81 | 1.47 |
| Example | 86 | Formed | — | 0.0000 | Cr | 0.0050 | Present | Amorphous phase | 5 | 0.73 | 1.44 |
| Example | 87 | Formed | — | 0.0000 | Cr | 0.0100 | Present | Amorphous phase | 6 | 0.73 | 1.42 |
| Example | 88 | Formed | — | 0.0000 | Cr | 0.0300 | Present | Amorphous phase | 6 | 0.81 | 1.30 |
| Example | 89 | Formed | — | 0.0000 | Bi | 0.0010 | Present | Amorphous phase | 5 | 0.77 | 1.48 |
| Example | 90 | Formed | — | 0.0000 | Bi | 0.0050 | Present | Amorphous phase | 5 | 0.73 | 1.41 |
| Example | 91 | Formed | — | 0.0000 | Bi | 0.0100 | Present | Amorphous phase | 5 | 0.73 | 1.39 |
| Example | 92 | Formed | — | 0.0000 | Bi | 0.0300 | Present | Amorphous phase | 5 | 0.84 | 1.27 |
| Example | 93 | Formed | — | 0.0000 | La | 0.0010 | Present | Amorphous phase | 5 | 0.81 | 1.46 |
| Example | 94 | Formed | — | 0.0000 | La | 0.0050 | Present | Amorphous phase | 5 | 0.84 | 1.39 |
| Example | 95 | Formed | — | 0.0000 | La | 0.0100 | Present | Amorphous phase | 5 | 0.88 | 1.35 |
| Example | 96 | Formed | — | 0.0000 | La | 0.0300 | Present | Amorphous phase | 5 | 0.92 | 1.40 |
| Example | 97 | Formed | — | 0.0000 | Y | 0.0010 | Present | Amorphous phase | 5 | 0.84 | 1.47 |
| Example | 98 | Formed | — | 0.0000 | Y | 0.0050 | Present | Amorphous phase | 5 | 0.81 | 1.47 |
| Example | 99 | Formed | — | 0.0000 | Y | 0.0100 | Present | Amorphous phase | 5 | 0.81 | 1.28 |
| Example | 100 | Formed | — | 0.0000 | Y | 0.0300 | Present | Amorphous phase | 5 | 0.81 | 1.26 |
| Example | 101 | Formed | Co | 0.1000 | Al | 0.0500 | Present | Amorphous phase | 4 | 1.00 | 1.49 |
| Example | 102 | Formed | Co | 0.1000 | Zn | 0.0500 | Present | Amorphous phase | 4 | 1.25 | 1.55 |
| Example | 103 | Formed | Co | 0.1000 | Sn | 0.0500 | Present | Amorphous phase | 4 | 1.29 | 1.54 |
| Example | 104 | Formed | Co | 0.1000 | Cu | 0.0500 | Present | Amorphous phase | 4 | 0.93 | 1.54 |
| Example | 105 | Formed | Co | 0.1000 | Cr | 0.0500 | Present | Amorphous phase | 4 | 1.04 | 1.46 |
| Example | 106 | Formed | Co | 0.1000 | Bi | 0.0500 | Present | Amorphous phase | 4 | 1.07 | 1.45 |
| Example | 107 | Formed | Co | 0.1000 | La | 0.0500 | Present | Amorphous phase | 4 | 1.14 | 1.51 |
| Example | 108 | Formed | Co | 0.1000 | Y | 0.0500 | Present | Amorphous phase | 4 | 1.04 | 1.44 |
| Example | 109 | Formed | Ni | 0.1000 | Al | 0.0500 | Present | Amorphous phase | 5 | 0.71 | 1.35 |
| Example | 110 | Formed | Ni | 0.1000 | Zn | 0.0500 | Present | Amorphous phase | 5 | 0.75 | 1.33 |
| Example | 111 | Formed | Ni | 0.1000 | Sn | 0.0500 | Present | Amorphous phase | 5 | 0.79 | 1.36 |
| Example | 112 | Formed | Ni | 0.1000 | Cu | 0.0500 | Present | Amorphous phase | 5 | 0.64 | 1.34 |
| Example | 113 | Formed | Ni | 0.1000 | Cr | 0.0500 | Present | Amorphous phase | 5 | 0.75 | 1.33 |
| Example | 114 | Formed | Ni | 0.1000 | Bi | 0.0500 | Present | Amorphous phase | 5 | 0.75 | 1.31 |
| Example | 115 | Formed | Ni | 0.1000 | La | 0.0500 | Present | Amorphous phase | 5 | 0.86 | 1.38 |
| Example | 116 | Formed | Ni | 0.1000 | Y | 0.0500 | Present | Amorphous phase | 5 | 0.75 | 1.31 |

From Table 4, in a case where the soft magnetic alloy had the glass transition temperature, and the number of exothermic peaks was within the above-described range, it was confirmed that good properties were obtained regardless of the composition of X1 and X2.

What is claimed is:

1. A soft magnetic alloy comprising:
Fe as a main component,
wherein the soft magnetic alloy has an amorphous phase,
a glass transition temperature Tg is found in a range from 350° C. to 600° C. and three or more exothermic peaks are found in a range from 350° C. to 850° C., on a differential scanning calorimetry curve of the soft magnetic alloy, and
wherein a composition of the soft magnetic alloy is represented by a composition formula of (Fe_{(1-(α+β))} X1_{α}X2_{β})_{(1-(a+b+c+d+e+f))}MₐB_{b}P_{c}Si_{d}CₑS_{f},
X1 is at least one selected from the group consisting of Co and Ni,
X2 is at least one selected from the group consisting of Al, Mn, Ag, Zn, Sn, As, Sb, Cu, Cr, Bi, N, O, and rare earth elements,
M is at least one selected from the group consisting of Nb, Hf, Zr, Ta, Mo, W, Ti, and V,
a, b, c, d, e, f, α, and β satisfy relationships of
0≤a≤0.140,
0.02<b≤0.200,
0≤c≤0.150,
0≤d≤0.175,
0≤e≤0.030,
0≤f≤0.010,
0.73≤(1−(a+b+c+d+e+f))≤0.91,
α≥0,
β≥0, and
0≤α+β≤0.50, and
at least one of c and d is larger than 0.

2. The soft magnetic alloy according to claim 1,
wherein the soft magnetic alloy consists of amorphous.

3. The soft magnetic alloy according to claim 1,
wherein the soft magnetic alloy has a nanoheterostructure in which initial fine crystals are present in the amorphous phase.

4. The soft magnetic alloy according to claim 1,
wherein the soft magnetic alloy has a ribbon shape.

5. The soft magnetic alloy according to claim 1,
wherein the soft magnetic alloy has a powder shape.

6. A magnetic part comprising:
the soft magnetic alloy according to claim 1.

7. A magnetic part comprising:
a soft magnetic alloy obtained by performing a heat treatment on the soft magnetic alloy according to claim 1 and having Fe-based nanocrystals.
